(19) United States
(12) Patent Application Publication
(10) Pub. No.: US 2016/0103961 A1
(43) Pub. Date: Apr. 14, 2016

(54) MEDICAL SYSTEM FOR UPLOADING MEDICAL DATA

(71) Applicant: COMPUGROUP MEDICAL AG, Koblenz (DE)

(72) Inventors: Werner Rodorff, Scottsdale, AZ (US); Jerry Maynard Kizziar, SR., Laveen, AZ (US)

(21) Appl. No.: 14/513,313

(22) Filed: Oct. 14, 2014

(51) Int. Cl. G06F 19/00

(52) U.S. Cl. CPC G06F 19/323

(57) ABSTRACT

The present disclosure relates to a mobile telecommunication device for use in a medical system comprising a database server. The mobile telecommunication device is configured for receiving via a voice channel interface from a user, a first voice message, the first voice message indicating one or more medical parameter values indicative of a medical status of the user; generating using the first voice message a second message in a first format interpretable by the database server; sending the second message to the database server using an identification address of the database server; receiving from the database server a response message indicating the interpreted message; displaying the received response message on a display device of the mobile telecommunication device; receiving a user command indicating that the medical status indicated in the response message is not corresponding with the medical status indicated in the first voice message.

### TECHNICAL FIELD

This invention relates generally to medical processing systems. More specifically, this invention relates to an improved apparatus and method for uploading medical data.

### BACKGROUND

The adoption of IT in healthcare systems becomes one of the more important aspects of care programs for different players in the healthcare industry. And most of the care programs are constrained to develop clinical procedures that involve IT services. However, a need remains for improving these clinical procedures such that patients around the world have comfortable use of IT services.

### SUMMARY

Various embodiments provide a method for uploading medical data, a medical system, a mobile telecommunication device and a database server as described by the subject matter of the independent claims. Advantageous embodiments are described in the dependent claims.

In one aspect, the invention relates to a method for operating a medical system, the medical system comprising a mobile telecommunication device, the mobile telecommunication device comprising a voice channel interface, the mobile telecommunication device being connected to a database server of the medical system, wherein the database server manages a database of the medical system. The method comprises:
a. receiving by the mobile telecommunication device via the voice channel interface from a user, a first voice message, the first voice message indicating one or more medical parameter values indicative of a medical status of the user;
b. generating by the mobile telecommunication device using the first voice message a second message in a first format interpretable by the database server;
c. sending by the mobile telecommunication device the second message to the database server using an identification address of the database server;
d. interpreting by the database server the received second message;
e. returning by the database server a response message to the mobile telecommunication device indicating the interpreted message;
f. displaying by the mobile telecommunication device the received response message on a display device of the mobile telecommunication device;
g. receiving at the mobile telecommunication device a user command indicating that the medical status indicated in the response message is not corresponding with the medical status indicated in the first voice message and repeating steps a)-f) when the user command is received;
h. storing by the database server the one or more medical parameter values in the database.

In another aspect, the invention relates to a tangible computer-readable recording medium comprising computer executable instructions to perform the method steps of the method of any one of the preceding embodiments.

In another aspect the invention relates to a medical system comprising a mobile telecommunication device, the mobile telecommunication device comprising a voice channel interface, the mobile telecommunication device being connected to a database server of the medical system, wherein the database server manages a database of the medical system, the medical system being configured to perform at least part of the method steps of above embodiments.

In another aspect, the invention relates to a mobile telecommunication device for use in the medical system according to the previous embodiment. The mobile telecommunication device is configured for:
receiving via the voice channel interface from a user a first voice message, the first voice message indicating one or more medical parameter values indicative of a medical status of the user;
generating using the first voice message a second message in a first format interpretable by the database server;
sending the second message to the database server using an identification address of the database server;
receiving from the database server a response message indicating the interpreted message;
displaying the received response message on a display device of the mobile telecommunication device;
receiving a user command indicating that the medical status indicated in the response message is not corresponding with the medical status indicated in the first voice message.

In another aspect, the invention relates to a database server for use in the medical system according to the previous embodiment. The database server is configured for:
receiving from the mobile telecommunication device a message;
interpreting the received message;
returning a response message to the mobile telecommunication device indicating the interpreted message;
storing one or more medical parameter values in the database indicated in the message.

### BRIEF DESCRIPTION OF THE DRAWINGS

In the following embodiments of the invention are explained in greater detail, by way of example only, making reference to the drawings in which:

FIG. 1 illustrates an exemplary medical system in accordance with the present disclosure,

FIG. 2 is a flowchart of a method of operating a mobile telecommunication device in accordance with the present disclosure,

FIG. 3 is a flowchart of a method of operating a database server in accordance with the present disclosure, and

FIG. 4 is a flowchart of a method of operating a medical system in accordance with the present disclosure.

### DETAILED DESCRIPTION

In the following, like numbered elements in the figures either designate similar elements or designate elements that perform an equivalent function. Elements which have been discussed previously will not necessarily be discussed in later figures if the function is equivalent.

The features of the above mentioned method may have the advantage of providing a user-friendly and simplified method for providing and storing accurate medical data. These features may lower the barrier of medical data entry (i.e. upload and storage) especially for untrained users with no or little IT experience.

For example, the database may be used as a common storage for medical data indicative of the medical status of multiple users. This may enable a centralized control of the medical statuses of the multiple users.

According to one embodiment, the storing of the one or more medical parameter values in the database in step h) is performed in case the response message matches the content of the second message. For example, the storing of step h) may be performed after a predefined waiting time period is elapsed (the fact that the waiting time period is elapsed without receiving a user command may be an indication that the response message matches the content of the second message). The predefined waiting time period may define a maximum time that it may take for the user command to be generated and to reach the database server. In other terms, if no command is received within that predefined waiting time period the database server may store the one or more medical parameter values in the database. A medical parameter value may comprise, for example, a numeric data, a string, and/or a symbol.

The mobile telecommunication device may comprise at least one of a mobile phone, measuring device, smartphone, PDA, a laptop, and a handheld medical device.

According to one embodiment, the one or more medical parameter values are stored in association with a user ID of the user of the mobile telecommunication device. The user ID may comprise, for example, the telephone number of the mobile telecommunication device from which a phone call may be made, an email address of the user or any information that may be identify the user. This information may be used to assign medical parameters with the user in the database. This may have the advantage of enabling authentication based up on the request, while conventional systems would require an already authenticated session. For example, since the phone number/email address/device ID may be stored in the database, there does not have to be a user authentication. This is in contrast to conventional methods in particular web based applications that require to capture this information and thus would have to have a pre authenticated session to tie the data elements to a patient/user.

This may also allow multiple user access to the database e.g. at the same time, wherein each of the multiple users has access to his own medical data only using the user ID.

According to one embodiment, the second message is at least one of an SMS message, and Email. This may have the advantage in that the present method may be seamlessly integrated in existing mobile telecommunication devices which are equipped with text messaging and Email services. In another example, the second message may comprise a voice message. In this case, the database server may comprise a voice recognition interface for receiving and interpreting the voice message.

The response message may comprise an SMS and/or Email message. For example, the second message and the response message may comprise the same type of messages e.g. SMS or Email. In another example, the response message and the second message may be of different message types e.g., the second message may comprise an SMS message while the response message may comprise an Email. This may, for example, prevent a malicious anticipation of the type of the response message (based on the second message) and thus may enable a secure communication between the mobile telecommunication device and the database server.

For example, the response message may be transmitted in data packets in addition to an optional control signal. For example, the data packets may control the mobile telecommunication device to launch a mobile application of the mobile telecommunication device. After being launched, the mobile application may automatically generate a user interface on the display of the mobile telecommunication device, wherein the user interface displays the content of the response message. The user interface may further display an “OK” and/or “RETRY” buttons such that the user may select one of the two buttons in order to confirm or acknowledge using the button “OK” the content of the response message so as to be recorded or to request using the button “RETRY” that the second message to be reformatted and reinterpreted by the database server. For example, when reformatting the second message only part of the medical parameters that have been miss-interpreted (or all the medical parameters of the miss interpreted second message) may be included in the reformatted second message since the parameter that may have been correctly interpreted by the database server may be stored. The mobile application may further comprise a voice recognition interface for interpreting received voice messages from a user of the mobile application, wherein the voice message may comprise an indication of the medical parameters of the user of the mobile application and/or comments on the response message that is displayed by the mobile application. This may further simplify the method for the user.

According to one embodiment, the generating of the second message using the first voice message in the repeated step b) is performed using a second format different from the first format and interpretable by the database server. By using different formats for communication with the database server, the present method may quickly converge to a stage where the database server interprets correctly the data sent by the mobile telecommunication device and indicating the medical status of the user. For example, the first format may be encoded as “parameter1”: value; “parameter2:value2” while the second format may be encoded as “parameter1”,“parameter2”;“value1”,“value2”, where parameterX refers to a medical parameter and valueX refers to a medical parameter value.

According to one embodiment, the first format comprises a format of the first voice message. The format of the first voice message may indicate, for example, the order in which are dictated the medical parameters and their values. This order may be the first format of the second message. For example, in case the second message is an SMS, it may be encoded such that a string indicating a medical parameter is immediately followed by the corresponding medical value (e.g., “parameter1”: value; “parameter2:value2” . . . ) as it was dictated. In alternative example, the first format may comprise a different format from the format of the first voice message e.g., the medical parameters may be listed first one after the other followed by their values (“parameter1”,“parameter2”;“value1”,“value2”).

The first and second format may be interpretable by the database server. For example, the database server may comprise an indication of the first format and the second format. The database server may indicate to the mobile telecommunication device the first and second format.

According to one embodiment, the interpreting of the second message comprises identifying in the second message at least part of the one or more medical parameters; reading in the second message parameter values associated with the identified parameters; encoding the parameter values into a storage format and storing the parameter values and parameters in the database in the storage format. The storage format may comprise for example the second format that the database server correctly interpreted. In another example, the storage format may comprise the first format. This may have the advantage of providing an easy subsequent access to the medical status of the user using the first format with which data has been dictated.

According to one embodiment, identifying comprises parsing the second message and plain text detecting the one or more medical parameters. The interpreting may comprise for example comparing the one or more medical parameters with locally stored parameters at the database server. For example, the second message may comprise texts in a natural language and the database server may comprise a dictionary that associates natural language words to a constructed language words of a program computer. The dictionary may be used by the database server for interpreting the second message.

The constructed language refers to a language such as programming language or markup language whose phonology, grammar, and vocabulary has been consciously devised for human or human-like communication, instead of having developed naturally.

The term parsing refers to the formal analysis by a computer of a sentence or other string of words into its constituents, resulting in a parse tree showing their syntactic relation to each other, which may also contain semantic and other information.

According to one embodiment, identifying the at least part of the one or more medical parameters comprises parsing the second message using a semantic analysis and extracting from the semantic the one or more medical parameters.

For example, the database server may identify words or strings (e.g., in natural language) that correspond with medical parameters contained in the second message and may perform a semantic analysis. This may further increase the accuracy of the medical data (i.e. the one or more parameter values) stored in the database as the medical parameters may be interpreted as they are originally received (e.g. in a natural language) from a user without passing through an intermediate data format that may alter the content of the medical data.

The term “semantic” as used herein refers to the meaning of a characteristic (e.g. that is described with a programming or natural language e.g. as a character) as interpreted by a software or hardware component having access to the characteristic. The software and/or hardware component may evaluate the meaning of the characteristic in order to use it in processing tasks involving the characteristic.

According to one embodiment, the sending and returning is performed using a steganography information security technique. This may provide a secure method for exchanging data between the telecommunication device and the database server in particular where the second message is a voice message. For example,

Steganography as an information security technique may be used to hide the medical parameter and/or their values within the voice or audio message, such that the information on the medical parameters and/or medical parameter values does not attract attention to itself as an object of scrutiny.

According to one embodiment, the voice channel interface is provided by a mobile application installed in the mobile telecommunication device. For example, the mobile telecommunication device may comprise a smartphone, wherein the mobile application may comprise, for example, Siri, Speaktoit, Skyvi or S-Voice app.

The voice channel interface may be, for example, a VoIP based interface.

The database server may comprise, for example, a web server that receives data from the mobile telecommunication device via a Web interface of the database server.

According to one embodiment, the step of sending the second message comprises establishing by the mobile telecommunication device a voice channel with the database server by the voice channel interface for transmitting voice data; transmitting the first voice message (as the second message) as an analogue and/or digital audio signal.

According to one embodiment, the communication between the mobile telecommunication device and the database server is performed using at least one of the communication protocols: Internet Protocol; Cellular network protocol; Fiber channel protocol; Bluetooth; Public switched telephone network protocol; Peer to peer protocol.

According to one embodiment, the second message is indicative of an identification of the mobile telecommunication device, wherein the identification comprises at least one of: phone number; IP address; Fiber Channel Address; URL; Port number; User ID; Email address. The identification of the mobile telecommunication device may be used, for example, for identifying the user of the mobile telecommunication device.

According to one embodiment, a medical parameter comprises at least one of: blood pressure; glucose level; body weight; pulse rate and any other clinical or vital parameter (or signs).

According to one embodiment, the identification address of the database server is automatically selected from a stored list of addresses in the mobile telecommunication device. For example, the selection of the identification address may be performed based on the availability e.g. available processing resources of the database server. The database server may be the server having the lowest processing load and/or associated with the highest free storage space among other database servers.

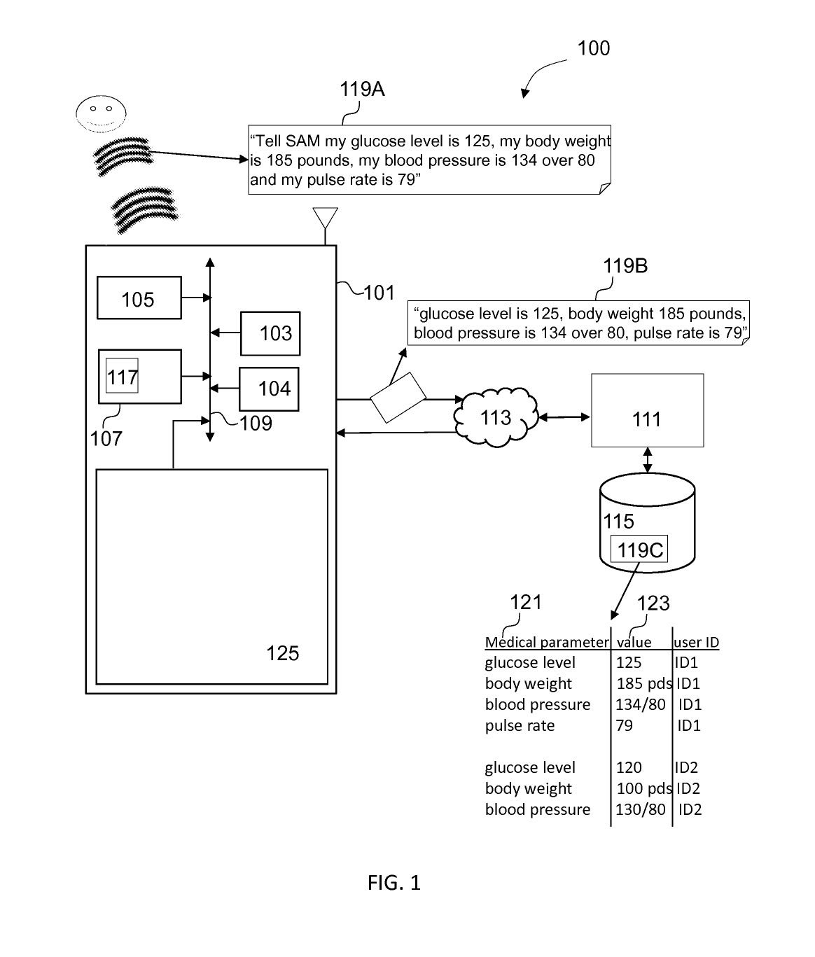

FIG. 1 illustrates an exemplary medical system 100. The medical system 100 may comprise a mobile telecommunication device 101. The mobile telecommunication device 101 may comprise a processor 103, a transceiver 105, a memory 107 each capable of communicating with one or more components of the mobile telecommunication device 101. For example, all components are coupled to a bidirectional system bus 109.

The processor 103 may be a microprocessor, a single core processor, a multicore processor or the like. The processor 103 may control the operation of the mobile telecommunication device 101. The transceiver 105 may be implemented as a transmitting and receiving component of the mobile telecommunication device 101.

The mobile telecommunication device 101 may further comprise a voice channel interface 104 for receiving voice messages e.g. 119A from a user of the mobile telecommunication device 101. The voice channel interface 104 may be a native voice recognition interface. The voice channel interface 104 may comprise, for example, a VoIP interface.

In another example, the mobile telecommunication device 101 may receive voice messages from a second user of a second telecommunication device that is in communication (e.g. via a phone call) with the user of the mobile telecommunication device 101. The second user may dictate data e.g. 119A containing one or more medical parameter values indicative of a medical status of the user (or second user), to be registered in the mobile telecommunication device 101.

The mobile telecommunication device 101 may further comprise a display device 125 which displays characters and images and the like. For example, the display device 125 may be a touch sensitive display screen.

The mobile telecommunication device 101 may be connected to a database server 111 of the medical system 100 through a communication network 113. The communication between the mobile telecommunication device 101 and the database server 111 may be performed using at least one of the communication protocols Internet Protocol, Cellular network protocol, Fiber channel protocol, Bluetooth communication protocol, Public switched telephone network protocol and Peer to peer protocol. The database server 111 may be part of a backend IT system.

For example, the mobile telecommunication device 101 may be directly connected to the database server 111 or may be connected indirectly via a base station (not shown) of a cellular-digital wireless telecommunication system serving the mobile telecommunication device 101 and/or the database server 111.

Using the transceiver 105, the mobile telecommunication device 101 may exchange data (e.g. 119B) with the database server 111 via the network 113. The database server 111 may manage or control a database 115. The database 115 may store data e.g. 119C related to different users including users of the mobile telecommunication device 101.

Memory 107 is configured to store one or more applications that are executable on the processor 103. A mobile application 117 of the mobile applications a personal assistant and knowledge manager that is a voice recognition application such as Siri for iOS devices and Speaktoit, Skyvi or S-Voice for Android devices.

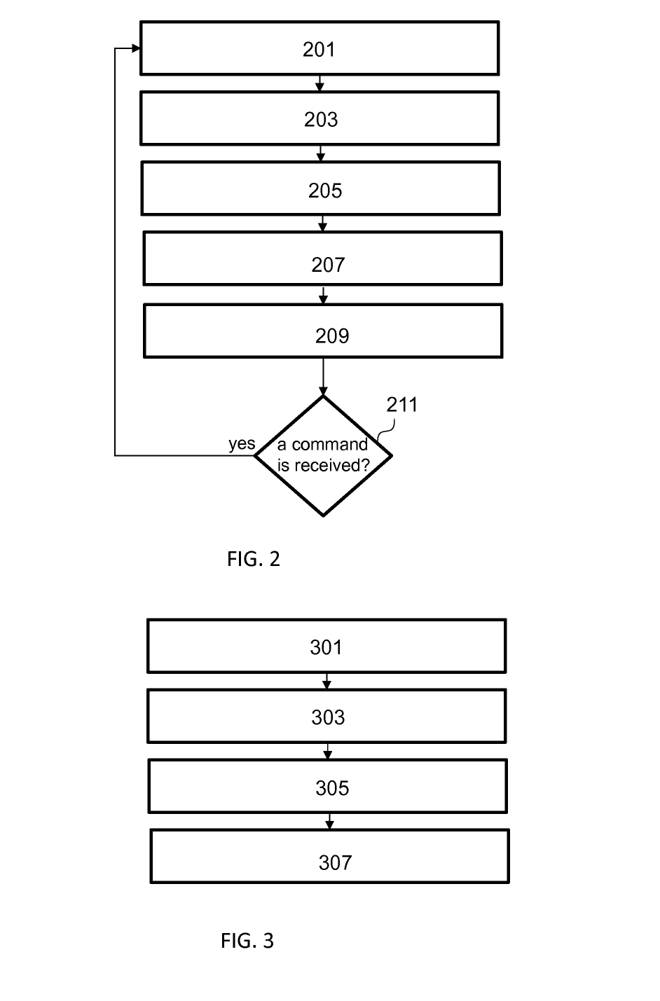

FIG. 2 is flowchart of a method for operating a mobile telecommunication device e.g. 101.

In block 201, the mobile telecommunication device 101 may receive via the voice channel interface 104 from a user, a first voice message 119A. For example, as soon as the mobile application 117 such as Siri is launched, the mobile telecommunication device 101 may be able to receive voice messages and record them.

The mobile application 117 may be launched or triggered by an interaction of the user of the mobile application 117 with the mobile telecommunication device 101. The mobile telecommunication device 101 may be equipped with a touch screen displaying different icons. The icons may be each associated with an application. The interaction comprises a selection of an icon of the mobile application 119 on a user interface or display 125 of the mobile telecommunication device 101 by the user.

The first voice message may indicate one or more medical parameter values indicative of a medical status of the user. For example, the medical parameters that are dictated in the first voice message 119A may comprise glucose level, body weight, blood pressure and/or pulse rate and their associated values. The first voice message 119A may be encoded or formatted, for example, in a natural language e.g. in English and/or German.

The user of the mobile telecommunication device 101 may be a user that is directly handling or having access to the mobile telecommunication device 101. In an alternative example, the user of the mobile telecommunication device may be a user who is associated with a second telecommunication device being in communication with the mobile telecommunication device 101 (e.g. via telecommunication means such as FaceTime). In this case, the first voice message 119A may further comprise a user ID indicative of the user of the second telecommunication device. The user ID may be used to be stored in association with the medical parameter values.

In block 203, the mobile telecommunication device 101 may generate using the first voice message 119A a second message 1198 in a first format interpretable by the database server. For example, the first voice message is 119A is encoded in a natural language format. This corresponds to the medical parameter followed by the value of the medical parameter. For sake of simplicity only a single format of the second message is described in FIG. 1. However, the skilled person having access to the present disclosure could use other formats.

For example, the second message may further indicate an identification of the mobile telecommunication device 101. Depending on the communication protocol being used between the mobile telecommunication device 101 and the database server 111 the identification may comprises at least one of phone number; IP address; Fiber Channel Address; URL; Port number; and Email address. The mobile telecommunication device 101 may further be identified by a user ID of the user of the mobile telecommunication device 101. The identification of the mobile telecommunication device 101 may be stored, for example, together with the medical parameter values in order to identify the user. It may also be used by the database server for sending the response message to the mobile telecommunication device 101.

In block 205, the mobile telecommunication device 101 may send the second message 1198 to the database server 111 using an identification address of the database server 111. Depending on the communication protocol being used for communication between the mobile telecommunication device 101 and the database server 111, the identification address may comprise, for example, IP address and/or Port number of the database server 111. The identification address of the database server 111 may be automatically selected from a stored list of addresses in the mobile telecommunication device 101 such as an address book that contains phone numbers and associated owners. For example, the selection of the identification address may be performed based on the availability e.g. available processing resources of the database server 111. The database server 111 may be the server having the lowest processing load and/or associated or having the highest free storage space among other database servers. In another example, the identification address may be derived from the first voice message 119A e.g., the database server 111 may be associated with a name “SAM” that may be indicated in the first voice message 119A. The name “SAM” may be used identify or select the identification address such as a phone number that may be stored in association with the name “SAM”.

In block 207, the mobile telecommunication device 101 may receive from the database server 111 a response message indicating an interpretation of the second message 1198 by the database server 111. The response message may have, for example, the format of the data 119C to be stored in the database 115. The response message may be sent to the mobile telecommunication device 101 using the identification obtained in the second message and obtained in block 203.

In block 209, the mobile telecommunication device 101 may display the received response message on the display device 125 of the mobile telecommunication device 101. For example, the mobile telecommunication device 101 may prompt the user for feedback on the content of the response message. It may for example display an “OK” and/or “RETRY” buttons such that the user may select one of the two buttons.

In block 211, if the mobile telecommunication device 111 receives a user command (e.g. when the button “RETRY” is selected) indicating that the medical status indicated in the response message is not corresponding with the medical status indicated in the first voice message 119A, the blocks 201-209 may be repeated. For example, a predefined waiting time period e.g. 10 min after displaying the response message in block 209 may be setup such that if the user command is not received within the waiting time period the method blocks 201-209 may not be repeated since the non-reception of the user command may indicate that the content of the response message corresponds or matches the content of the second message. In another example, if the “OK” button is selected the method blocks 201-209 may not be repeated.

FIG. 3 is a flowchart of a method for operating a database server e.g. 111.

In block 301, the database server 111 may receive from the mobile telecommunication device 101 a message 119B. The message 119B may indicate for example medical parameters and their values that indicate a medical status of the user of the mobile telecommunication device 101.

In block 303, the database server 111 may interpret the received message. For example, the database server 111 may use an interpreter of the database server 111 in order to interpret the message 119B. The interpreter may comprise an indication or a description of the format in which the message 119B is encoded. For example, the database server 111 may use the indication or the description to interpret that the verb “is” as a separation between the medical parameter and its value i.e. the string first read before “is” is the medical parameter and the value read after “is” is the value of the medical parameter. The database server 111 may interpret using the description or indication the comma “,” as a separation between different medical parameters e.g. after reading the comma the database server 111 may interpret the following string being read as another medical parameter. Further, the database server 111 may interpret the left hand quotation mark as the start of the message 119B and the right hand quotation mark as the end of the message 119B.

For example, the database server 111 may look for key words using a phrase dictionary e.g., “Blood Glucose”, “Glucose Level”, “Blood Sugar”, “Blood Sugar Level” etc, are stored against the vocabulary items primary key for ‘blood glucose level’. So a look or a search for any of these phrases within the dictionary is performed to get the primary key, then using the value type, i.e. Integer, Double, text, the value following the parameter may be interpreted. For example, in expression “My blood sugar is 100”, “blood sugar” is found which is tied to the internal primary key of ‘blood glucose level’, which is stored as an integer so the integer to the right of ‘blood sugar’ is captured as the value.

In block 305, the database server 111 may return a response message to the mobile telecommunication device 101 indicating the interpreted message. For example, the database server 111 may encode or format the response message in the storage format indicated by the message or table 119C.

In block 307, the database server 111 may store one or more medical parameter values 123 in the database 115 indicated in the message 1198. For example, the database server 111 may store the one or more medical parameter values 123 in case the predefined waiting time period defined above has elapsed. In another example, the database server 111 may receive a storage request from the mobile telecommunication device 101 for storing the one or more medical parameter values 123.

The one or more medical parameter values may be stored for example in a table where a first column is assigned to the medical parameter 121 definition, a second column is assigned to the medical parameter value 123 and a third column indicating a user ID (e.g. as defined in the first voice message 119A in block 201. The user ID may also be derived from the identification of the mobile telecommunication device 101 contained in the message 1198 as defined in block 203) of the user having the medical status indicated by the medical parameter values 123.

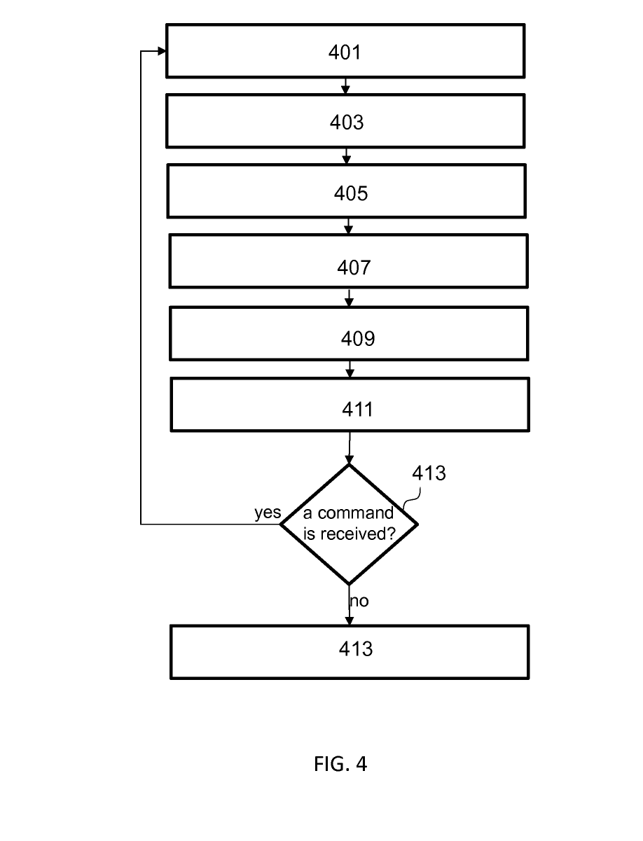

FIG. 4 is a flowchart of a method of operating the medical system 100.

In block 401 the mobile telecommunication device 101 may receive via the voice channel interface 104 from a user, a first voice message 119A. The first voice message 119A indicates one or more medical parameter values indicative of a medical status of the user.

In block 403, the mobile telecommunication device 101 may generate using the first voice message 119A a second message 1198 in a first format interpretable by the database server 111.

In block 405, the mobile telecommunication device 101 may send the second message 1198 to the database server 111 using an identification address of the database server 111.

In block 407, the database server 111 may interpret the received second message 119B.

In block 409, the database server 111 may return a response message to the mobile telecommunication device 101 indicating the interpreted message.

In block 411, the mobile telecommunication device 101 may display the received response message on the display device 125 of the mobile telecommunication device 101.

In block 413, if the mobile telecommunication device 101 receives a user command indicating that the medical status indicated in the response message is not corresponding with the medical status indicated in the first voice message 119A blocks 401-411 may be repeated.

In block 415, the database server 111 may store the one or more medical parameter values 123 in the database 115.

In a following simplified example Siri may be used for entering and uploading structured data into backend IT systems e.g. such as database server 111.

The following example describes a way to easily upload structured data with natural language into backend IT systems. This may be particularly advantageous for untrained users with no or little IT experience, still a huge barrier.

Also, standard user interfaces offered by applications not available on smartphones e.g. 101 or tablets (like web or client/server applications) require access to a running computer. If, on the flip side, only small amounts of information need to be entered (as an example the daily blood sugar and vitals measurements for diabetic patients or other chronic diseases), a natural language interface e.g. 104 combined with the use of a smartphone 101 lowers the barrier of data entry significantly.

Natural language interfaces may comprise for iOS devices: Siri or for Android equipped devices: Speaktoit, Skyvi or the S-Voice app for the Samsung Galaxy S3.

In this example, these applications may be configured and used to create a text, SMS message or an email by natural speaking into the natural language interface 104 that is then sent to a server e.g. 111. The server 111 scans the text message for certain keywords and data elements and stores the results in the database 115. The phone number of the smartphone 101 or the email address of the sender (e.g. the user of the smartphone 101) is used to identify the user who has transmitted the message. With that, the data could then be stored into the IT systems database 115 or used for other purposes like performing desired actions of executing commands. The phone number of the server 111 could typically be stored on the smartphone 101 or equivalent device in the devices contacts under a meaningful and reasonable contact name. For validation purposes the server 111 sends a text or email message back to the smartphone 101, communicated what was understood and which actions had been or to be performed. The actions may comprise a submission of a success or failure type response.

For example, for a message indicating “My glucose level is 100, and my pulse is 60”, all parameters are found and data types are matched, so the server 111 would respond with a success type e.g., “We have entered your Glucose Level as 100 and Pulse Rate as 60 beats per minute”.

In another example, the message may indicate “My glucose is 100 and my pulse is nifty”, the parameters exist but pulse is an invalid data type that is unmatched, this would reply by server 111, “I didn't quite get that. What was your Pulse?”, then a second message may be sent as a response containing ‘My Pulse is 50’, then the server 111 would respond with ‘We have entered your Glucose Level as 100 and Pulse Rate as 50 beats per minute’.

As an example using Siri on iOS devices, the user would start Siri, Siri is then listening to any commands. To, for example, report on daily blood sugar measurements and other vital data for a diabetic patient to a server 111 which phone number is stored in the smartphones contacts under the name SAM, the user would speak into Siri: User: “Tell SAM my glucose level is 125, my body weight 185 pounds, my blood pressure is 134 over 80 and my pulse rate is 79” Siri would ask for confirmation and if confirmed send the message to the server 111. At the server 111, the text message is scanned for the keywords “glucose”, “body weight”, “blood pressure” and “pulse”. Synonyms are possible e.g., instead of glucose the user could also say “blood sugar”. Any number after the keyword is threated as the corresponding value of the keyword. So in the above example, the glucose level is assumed to be 125, the body weight 185 lbs etc. . . . . The date and time of the measurement may be taken from the date and time the text message is sent or through another natural language keyword such as “Yesterday at 2:45 PM my blood sugar was . . . ” The server 111 responds with a text message like: “Firstname Lastname, on dd/mm/yyyy at hh:mm your glucose has been recorded into your diabetic journal as 125, body weight as 185 lbs. For example, in case these measures are incorrect the smartphone 101 sends a text message to SAM that contains “Cancel” or resend the text message but in other format that may be correctly interpreted by the server 111. With this, the user may verify the data entered and has the option to delete the data in case of errors.

This example is not only restricted to data entry of numeric data, any kind of structured data could be recognized and transmitted. In the case the patient should also report how she/he feels, picking any qualifier from the following list (well, not too bad, bad, horrible), a possible entry into Siri could be “Today my personal feeling is excellent”.

### LIST OF REFERENCE NUMERALS

100 medical system,
101 mobile telecommunication device,
103 processor,
104 voice channel interface,
105 transceiver,
107 memory,
109 bus,
111 database server,
113 network,
115 database,
119A first voice message,
119B second message,
119C stored data,
121 medical parameter,
123 medical parameter value,
125 display.

1. A method for operating a medical system, the medical system comprising a mobile telecommunication device, the mobile telecommunication device comprising a voice channel interface, the mobile telecommunication device being connected to a database server of the medical system, wherein the database server manages a database of the medical system, the method comprising:
a. receiving by the mobile telecommunication device via the voice channel interface from a user, a first voice message, the first voice message indicating one or more medical parameter values indicative of a medical status of the user;
b. generating by the mobile telecommunication device using the first voice message a second message in a first format interpretable by the database server;
c. sending by the mobile telecommunication device the second message to the database server using an identification address of the database server;
d. interpreting by the database server the received second message;
e. returning by the database server a response message to the mobile telecommunication device indicating the interpreted message;
f. displaying by the mobile telecommunication device the received response message on a display device of the mobile telecommunication device;
g. receiving at the mobile telecommunication device a user command indicating that the medical status indicated in the response message is not corresponding with the medical status indicated in the first voice message and repeating steps a)-f) when the user command is received;
h. storing by the database server the one or more medical parameter values in the database.

2. The method of claim 1, wherein the one or more medical parameter values are stored in association with a user ID of the user of the mobile telecommunication device.

3. The method of claim 1, wherein the second message is at least one of:
SMS message;
Email.

4. The method of claim 1, wherein the generating of the second message using the first voice message in the repeated step b) is performed using a second format different from the first format and interpretable by the database server.

5. The method of claim 1, wherein the first format comprises a format of the first voice message.

6. The method of claim 1, wherein the interpreting of the second message comprises:
identifying in the second message at least part of the one or more medical parameters;
reading in the second message, parameter values associated with the identified parameters;
encoding the parameter values into a storage format and storing the parameter values and parameters in the database in the storage format.

7. The method of claim 6, wherein identifying comprises parsing the second message and plain text detecting the one or more medical parameters.

8. The method of claim 6, wherein identifying the at least part of the one or more medical parameters comprises parsing the second message using a semantic analysis and extracting from the semantic the one or more medical parameters.

9. The method of claim 1, wherein the sending and returning is performed using a steganography information security technique.

10. The method of claim 1, wherein the voice channel interface is provided by a mobile application installed in the mobile telecommunication device.

11. The method of claim 1, wherein the communication between the mobile telecommunication device and the database server is performed using at least one of the communication protocols:
Internet Protocol;
Cellular network protocol;
Fiber channel protocol;
Bluetooth;
Public switched telephone network protocol;
Peer to peer protocol.

12. The method of claim 1, wherein the second message is indicative of an identification of the mobile telecommunication device, wherein the identification comprises at least one of:
phone number;
IP address;
Fiber Channel Address;
URL;
Port number
User ID
Email address.

13. The method of claim 1, wherein a medical parameter comprises at least one of:
blood pressure;
glucose level;
body weight;
pulse rate.

14. The method of claim 1, wherein the identification address of the database server is automatically selected from a stored list of addresses in the mobile telecommunication device.

15. A medical system comprising a mobile telecommunication device, the mobile telecommunication device comprising a voice channel interface, the mobile telecommunication device being connected to a database server of the medical system, wherein the database server manages a database of the medical system, the medical system being configured to perform at least part of the method steps of claim 1.

16. A mobile telecommunication device for use in a medical system according to claim 15, the mobile telecommunication device being configured for:
receiving via the voice channel interface from a user, a first voice message, the first voice message indicating one or more medical parameter values indicative of a medical status of the user;
generating using the first voice message a second message in a first format interpretable by the database server;
sending the second message to the database server using an identification address of the database server;
receiving from the database server a response message indicating the interpreted message;
displaying the received response message on a display device of the mobile telecommunication device;
receiving a user command indicating that the medical status indicated in the response message is not corresponding with the medical status indicated in the first voice message.

17. A database server of for use in a medical system according to claim 15, the database server being configured for:
receiving from the mobile telecommunication device a message;
interpreting the received message;
returning a response message to the mobile telecommunication device indicating the interpreted message;
storing one or more medical parameter values in the database indicated in the message.
